(19) United States
(12) Patent Application Publication
(10) Pub. No.: US 2013/0009592 A1
(43) Pub. Date: Jan. 10, 2013

(54) AUTONOMOUS DEVICE BATTERY EXCHANGE

(75) Inventors: Glen C. Larsen, Issaquah, WA (US); Russ Sanchez, Seattle, WA (US)

(73) Assignee: MICROSOFT CORPORATION, Redmond, WA (US)

(21) Appl. No.: 13/178,886

(22) Filed: Jul. 8, 2011

(51) Int. Cl. H02J 7/00

(52) U.S. Cl. 320/107

(57) ABSTRACT

Various embodiments related to automatically exchanging a discharged battery for a charged battery in an autonomous device are disclosed. For example, one disclosed embodiment provides a method of operating an autonomous device, the method including autonomously moving to and operatively engaging with a battery exchange dock such that a discharged battery in the autonomous device is automatically removed from the autonomous device and placed into a charging receptacle on the battery exchange dock and a charged battery is automatically received from the battery exchange dock by the autonomous device. The method further includes autonomously disengaging from the battery exchange dock after receiving the charged battery.

### BACKGROUND

An autonomous device, such as a mobile autonomous robot, may utilize one or more batteries as a power supply. In an autonomous device with rechargeable batteries, the autonomous device may be configured to locate, move to, and engage with a battery recharging docking station to allow battery recharging to occur without human intervention.

### SUMMARY

Various embodiments related to automatically exchanging a discharged battery for a charged battery in an autonomous device are disclosed. For example, one disclosed embodiment provides a method of operating an autonomous device, the method comprising autonomously moving to and operatively engaging with a battery exchange dock such that a discharged battery in the autonomous device is automatically removed from the autonomous device and placed into a charging receptacle on the battery exchange dock, and a charged battery is automatically received from the battery exchange dock by the autonomous device. The method further includes autonomously disengaging from the battery exchange dock after receiving the charged battery.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a flow diagram depicting an embodiment of a method of automatically exchanging batteries in an autonomous device.

FIG. 2 shows an embodiment of an autonomous device.

FIG. 3 shows a block diagram of the autonomous device of FIG. 2, and also shows a block diagram of an embodiment of a battery exchange dock.

FIG. 4 shows an embodiment of a battery receptacle of the autonomous device of FIG. 2.

FIG. 5 shows an embodiment of a battery configured to be inserted into the battery receptacle of FIG. 4.

FIG. 6 shows a sectional view of the battery and battery receptacle of FIG. 5.

FIG. 7 shows the autonomous device of FIG. 3 interfacing with an embodiment of a battery exchange dock.

FIG. 8 shows the battery exchange dock of FIG. 7 holding the battery of FIG. 7.

FIG. 9 shows a sectional view of arms of the battery exchange dock of FIG. 7 engaged with the battery of FIG. 5.

FIG. 10 shows a view of an arm of the battery exchange dock of FIG. 7.

FIGS. 11-14 illustrate an embodiment of a method of automatically exchanging batteries in an autonomous device.

FIGS. 15-18 illustrate another embodiment of a method of automatically exchanging batteries in an autonomous device.

FIGS. 19-23 illustrate another embodiment of a method of automatically exchanging batteries in an autonomous device.

### DETAILED DESCRIPTION

As mentioned above, an autonomous device may be configured to locate, move to, and engage with a battery recharging docking station to recharge an on-board battery. However, recharging a battery at a docking station may take a significant amount of time, during which the autonomous device may not be useable.

Thus, various embodiments are disclosed herein that relate to automatically exchanging a discharged battery in an automated device for a charged battery. In the disclosed embodiments, a battery exchange docking station is utilized to charge a battery when the battery is outside of and disconnected from a corresponding autonomous device. Further, the battery exchange docking station and/or the autonomous device includes a battery exchanging mechanism configured automatically exchange a charged battery on the docking station with a discharged battery on the autonomous device. Thus, while the autonomous device is away from the docking station and being powered by one or more batteries, one or more other batteries may be charged in the docking station. Then, the autonomous device may occasionally operatively engage with the docking station to undergo an automatic battery exchange process in which the discharged battery on the autonomous device is exchanged with a charged battery from the docketing station. In this manner, the autonomous device may obtain a freshly charged battery with less downtime than if the battery were recharged while in the autonomous device, and without human intervention. It will be understood that the terms “charged battery” and “discharged battery” as used herein refer to whether a battery was most recently charged via a docking station or discharged via autonomous device operation, and is not intended to signify any particular charge state of a battery relative to a fully charged or discharged state.

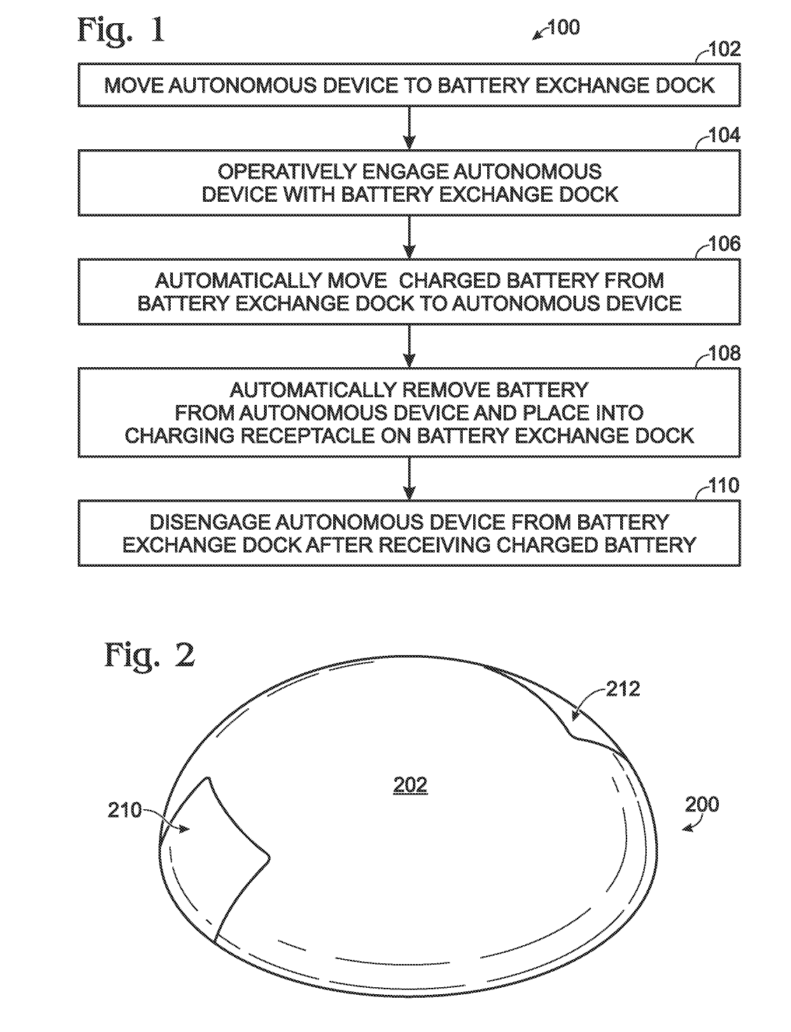

FIG. 1 shows a flow diagram depicting an embodiment of a method 100 of exchanging batteries in an autonomous device. Method 100 comprises, at 102, autonomously moving an autonomous device to a battery exchange dock, and at 104, autonomously operatively engaging the autonomous device with the battery exchange dock. The autonomous device may be configured to move to the battery exchange dock upon the occurrence of any suitable event or trigger. For example, an autonomous device may be configured to exchange batteries on a preset schedule, or when a battery reaches a preselected discharge level.

Upon occurrence of such a trigger, the autonomous device may locate the battery exchange dock in any suitable manner, and then autonomously move into operative engagement the battery exchange dock to participate in a battery exchange process. Next, after operatively engaging with the battery exchange dock, method 100 comprises, at 106, automatically placing a charged battery from the battery exchange dock into the autonomous device, and at 108, automatically removing a discharged battery from the autonomous device and placing it into a charging receptacle on the battery exchange dock. After the discharged battery has been placed in the charging receptacle of the autonomous device and the charged battery has been placed in the autonomous device, method 100 comprises, at 110, autonomously disengaging the autonomous device from the battery exchange dock while the discharged battery is being charged on the battery exchange dock. In this manner, the autonomous device may be provided with a freshly charged battery with potentially substantially less down time than where a battery is charged while remaining within an autonomous device.

In some embodiments, the charged battery may be provided to the autonomous device prior to removal of the discharged battery. In such embodiments, power may be continuously supplied to the autonomous device by the batteries being exchanged during the exchange process. This may allow the autonomous device to maintain an operative state during battery exchange, which may facilitate the participation of the autonomous device in the battery exchange process, for example, by moving to place different battery receptacles into proper alignment for battery exchange.

In other embodiments, the discharged battery may be removed prior to receipt of the charged battery by the autonomous device. In such embodiments, the autonomous device may comprise a secondary power supply, such as a secondary battery, supercapacitor, or other suitable charge storage device, to provide power to the autonomous device during a battery exchange process. Alternatively, in other embodiments, the autonomous device may be powered by the dock during battery exchange, or in yet other embodiments, the autonomous device may power down during battery exchange.

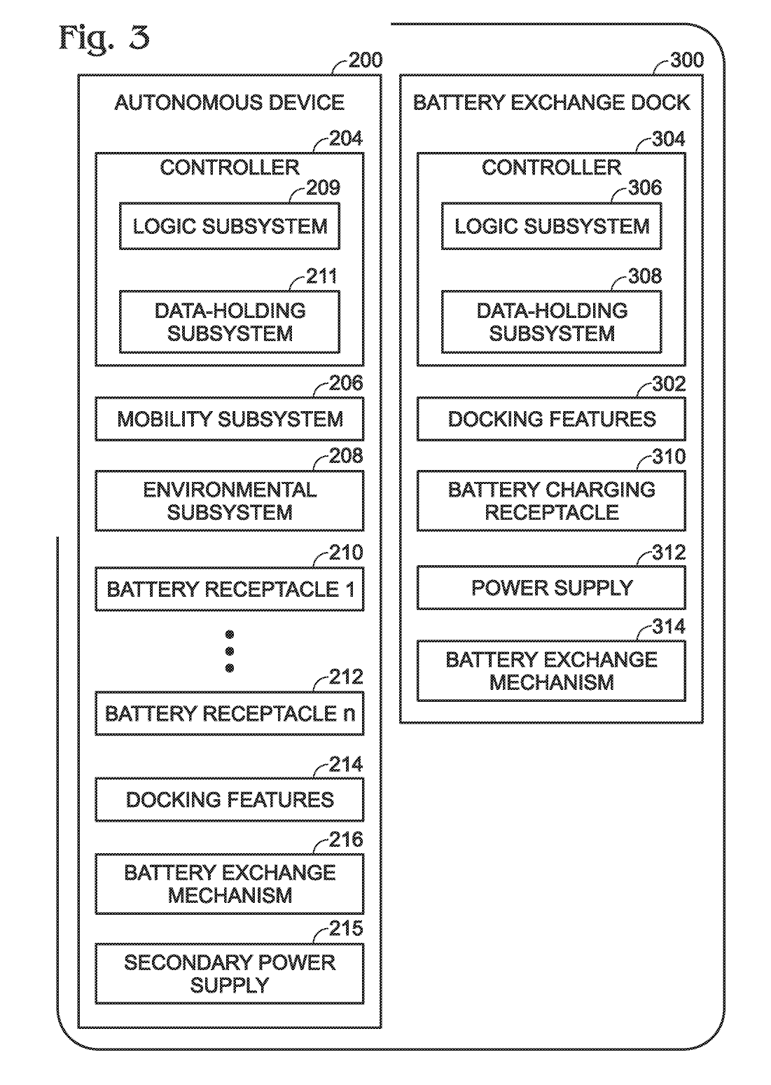

FIG. 2 shows an example embodiment of an autonomous device 200 in the form of an autonomous mobile robot, and FIG. 3 shows a block diagram of autonomous device 200. Autonomous device 200 comprises a body 202 encompassing various systems. Referring to FIG. 3, examples of such systems may include, but are not limited to, a controller 204, a mobility subsystem 206 controllable by controller 204 to enable autonomous motion, and one or more environmental sensors 208, such as image sensors, motion sensors, tilt sensors, and/or any other sensor or sensors suitable to allow autonomous device 200 to navigate through a use environment and/or perform desired tasks.

Controller 204 comprises a logic subsystem 209, and a data-holding subsystem 211 configured to hold instructions that are executable by the processor to perform tasks related to exchanging batteries, among other tasks. These subsystems are described in more detail below.

Autonomous device 200 further comprises a plurality of battery receptacles each configured to hold one or more batteries to independently provide power to the various components of autonomous device 200. In the embodiment of FIG. 2, autonomous device 200 comprises a first battery receptacle 210 and a second battery receptacle 212 each configured to hold a battery to independently power autonomous device 200. As such, autonomous device may operate with one of battery receptacles 210, 212 empty when a sufficiently charged battery is in the other battery receptacle. Receptacles 210, 212 are positioned on different locations or sides around a perimeter of the body of autonomous device 200, such that autonomous device 200 may rotate around a central axis to position battery receptacles 210 for battery exchange. While the embodiment of FIG. 2 comprises two battery receptacles 210, 212, it will be understood that an autonomous device may comprise any suitable number of battery receptacles each configured to hold one or more batteries. This is illustrated in FIG. 3 by an arbitrary number n of battery receptacles, where n is equal to two in the specific embodiment of FIG. 2.

Continuing with FIG. 3, autonomous device 200 further may comprise one or more docking features 214 configured to assist with operatively engaging a battery exchange dock 300 to enable battery exchange to take place. Such docking features may help autonomous device 200 to align with battery exchange dock 300 during a docking process, and also may help to electronically and/or mechanically trigger the commencement of a battery exchange process. Any suitable docking features 214 may be used, including but not limited to mechanical, magnetic, inductive, conductive, structural and/or optical features. As more specific examples, mechanical and/or structural features may help guide autonomous device 200 onto battery exchange dock 300 into a correct position for a battery exchange process, while optical features may be read by an optical sensor on autonomous device 200 or battery exchange dock 300 to confirm proper positioning of the autonomous device 200 on battery exchange dock 300. It will be understood that battery exchange dock 300 may include docking features 302 complementary to docking features 214.

As mentioned above, in some embodiments, an automated device may be configured to undergo a battery exchange operation by removal of a discharged battery before insertion of a charged battery. Thus, autonomous device 200 may comprise an optional secondary power source 215, such as a secondary battery, supercapacitor, or other suitable device, to provide power during a battery exchange process. Further, as mentioned above, the autonomous device may receive power from the battery exchange dock during battery exchange.

Battery exchange dock 300 comprises a controller 304 including a logic subsystem 306 and a data-holding subsystem 308 comprising instructions stored thereon that are executable by the logic subsystem to perform tasks related to exchanging batteries in an autonomous device, charging batteries, etc. These subsystems are described in more detail below. It will be understood that control logic and data also may be provided to battery exchange dock 300 by autonomous device 200 during docking, and therefore may be omitted from battery exchange dock 300 in some embodiments.

Additionally, battery exchange dock 300 further comprises a battery charging receptacle 310, and a power supply 312, such as an unlimited power source (e.g. a power cord configured to plug into a wall jack), or a power source of greater capacity than the battery or batteries being charged. It will be understood that autonomous device 200 and/or battery exchange dock 300 may include any other suitable components not shown herein, including but not limited to communications subsystems to allow the autonomous device and battery exchange dock to communicate with each other and with other device (e.g. via a network), display subsystems, etc.

Any suitable battery exchanging mechanism may be used to effect the exchange of a discharged battery for a charged battery in autonomous device 200. For example, an exchange mechanism may be located on battery exchange dock 300, as indicated at 314, on autonomous device 200, as indicated at 216, or distributed between autonomous device 200 and battery exchange dock 300. Specific example embodiments of battery exchange mechanisms are described in more detail below.

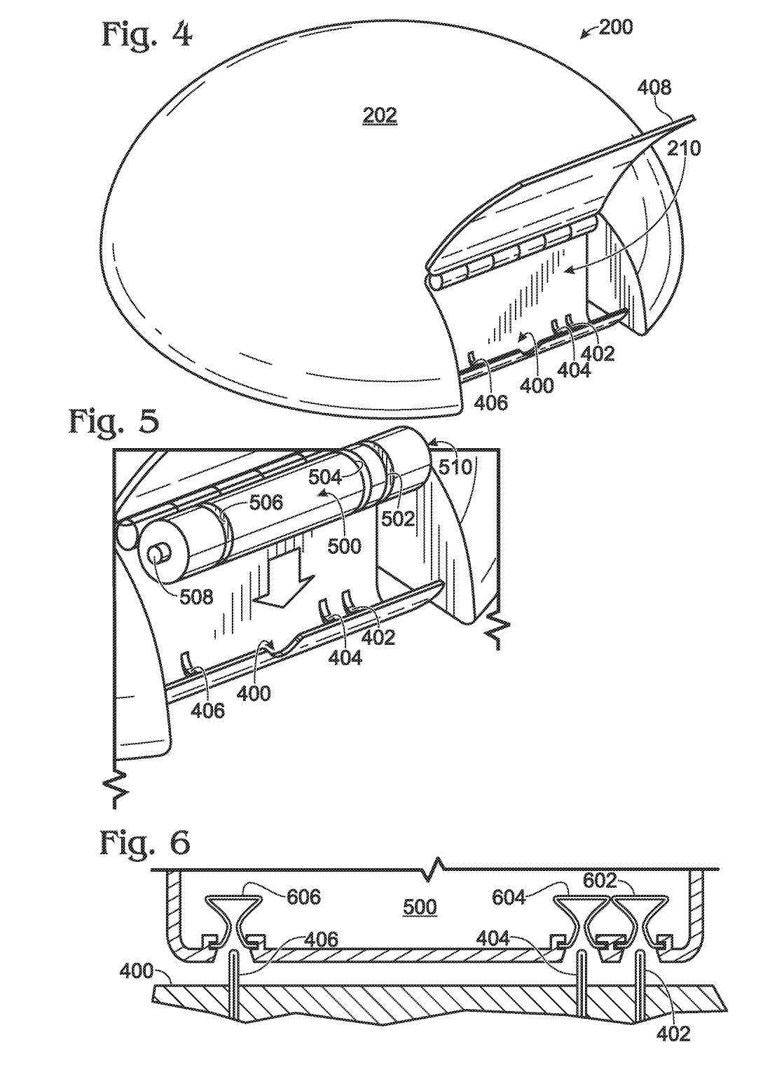

Battery receptacles 210, 212 may have any suitable configuration for retaining a battery and electrically connecting the battery to circuitry in autonomous device 200. FIG. 4 shows an example embodiment of battery receptacle 210, and FIG. 5 shows a battery 500 configured for use with the battery receptacle of FIG. 4. It will be understood that the embodiment of FIGS. 4 and 5 are presented for the purpose of example, and are not intended to be limiting in any manner, as features including but not limited to alignment, guides, and contacts may have any suitable configurations. Battery receptacle 210 comprises a battery holding tray 400 comprising a plurality of features 402, 404, 406 that extend from a bottom portion of tray 400, wherein features 402, 404, 406 are configured to extend into complementary recesses 502, 504, 506 on battery 500. Battery receptacle 210 further comprises a door 408 which may be opened for access during a battery exchange process, and closed during ordinary autonomous device usage.

Ribs 402, 404, 406 may comprise electrical contacts configured to form a conductive path with complementary contacts contained within rececesses 502, 504, 506 of battery 500. This is illustrated in FIG. 6, which shows electrical contacts 602, 604, 606 in the form of conductive clamps configured to pinch contacts 402, 404, 406. While the depicted embodiment comprises three contacts per battery receptacle, it will be understood that any other suitable number of contacts may be used, depending upon battery configuration. It further will be understood that any other suitable battery and battery contact configuration may be used, including but not limited to battery contacts located on either end, on the side or sides, on the outer surfaces, etc. of battery 500. Likewise, it will be understood that any suitable battery having any suitable shape may be utilized.

Referring briefly back to FIG. 5, battery 500 comprises battery holding structures 508, 510 configured to allow a battery exchange mechanism to hold battery 500 during an exchange process. The depicted battery holding structures 508, 510 take the form of pin-like extensions that extend from either end of an elongate body of battery 500. However, it will be understood that a battery may include any other suitable exchange system interface structures. Further, in some embodiments, an exchange mechanism may be configured to hold a battery via standard battery features that are not specially adapted to interface with an exchange system.

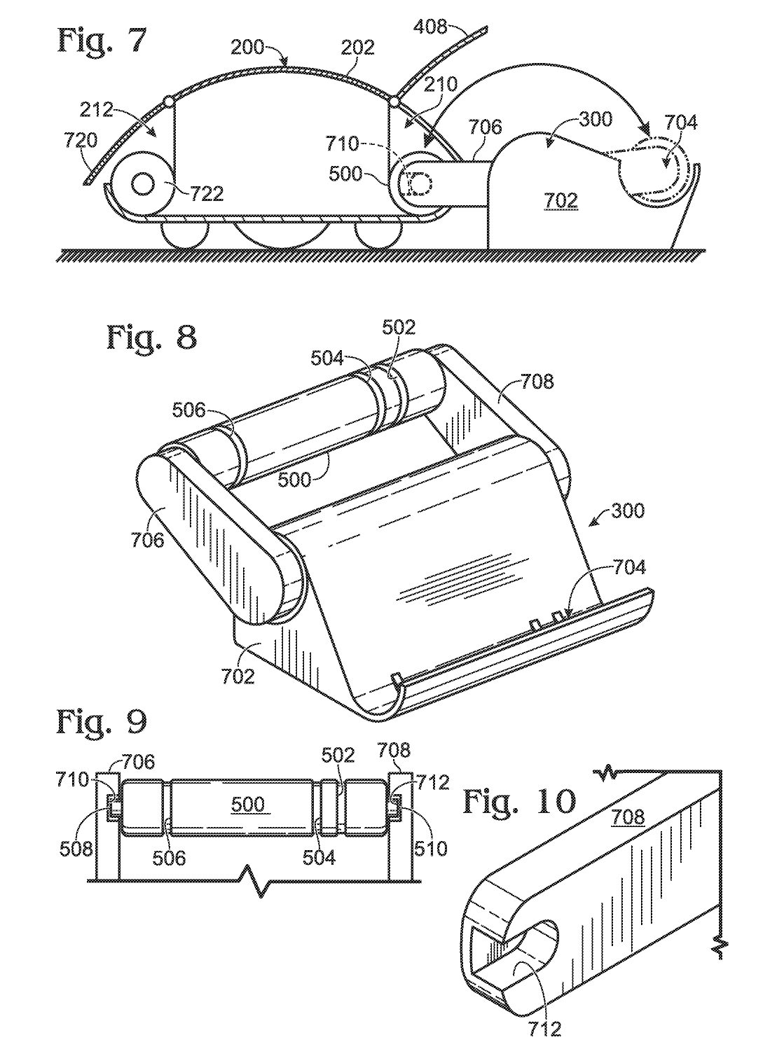

FIGS. 7-8 show an example embodiment of a battery exchange dock 300 configured to exchange and charge battery 500. Battery exchange dock 300 comprises a base 702 having a battery charger 704 with electrical contacts complementary to contacts on battery 500. Battery exchange dock 300 further comprises a pair of mechanically actuatable battery exchange arms 706, 708 movably coupled to base 702, wherein arms 706, 708 are configured to move a battery between battery charger 704 and autonomous device 200. Each arm 706, 708 comprises a slot 710, 712 configured to accommodate one or battery holding structures 508, 510 respectively, as illustrated in FIGS. 9 and 10. Further, in some embodiments, arms 706, 708 also may include retention features (not shown) electronically and/or mechanically actuatable to secure battery 500 within arms 706, 708 while moving battery 500 between autonomous device 200 and battery exchange dock 300.

Referring to FIG. 7, a battery exchange process may proceed as follows. First, autonomous device 200 autonomously moves into position to receive a freshly charged battery from battery exchange dock 300. As mentioned above, any suitable mechanism may be used to properly align autonomous device 200 with battery exchange dock 300 for an exchange process. For example, in the depicted embodiment, autonomous device 200 may approach battery exchange dock 300 in such a manner that arms 706, 708 extend into complementary recesses located on either side of door 408 to trigger the opening of door 408. Next, door 408 may open, for example, by electric motor, springs, or other compliant mechanism, to allow access to the empty battery receptacle 210. Then, arms 706, 708 lift battery 500 from battery charger 704, and move battery 500 into battery receptacle 210. It will be understood that any other suitable mechanism may be used to trigger an exchange process.

After receiving freshly charged battery 500, autonomous device 200 may close door 408 and rotate around a central axis, or otherwise move, to bring battery receptacle 212 into proper alignment with arms 706, 708 of battery exchange dock 300. Then, door 720 of battery receptacle 212 may be opened to allow arms 706, 708 to remove battery 722 for recharging. After battery 722 is removed, autonomous device 200 may autonomously disengage from battery exchange dock 300, thereby leaving battery 722 to charge on battery exchange dock 300.

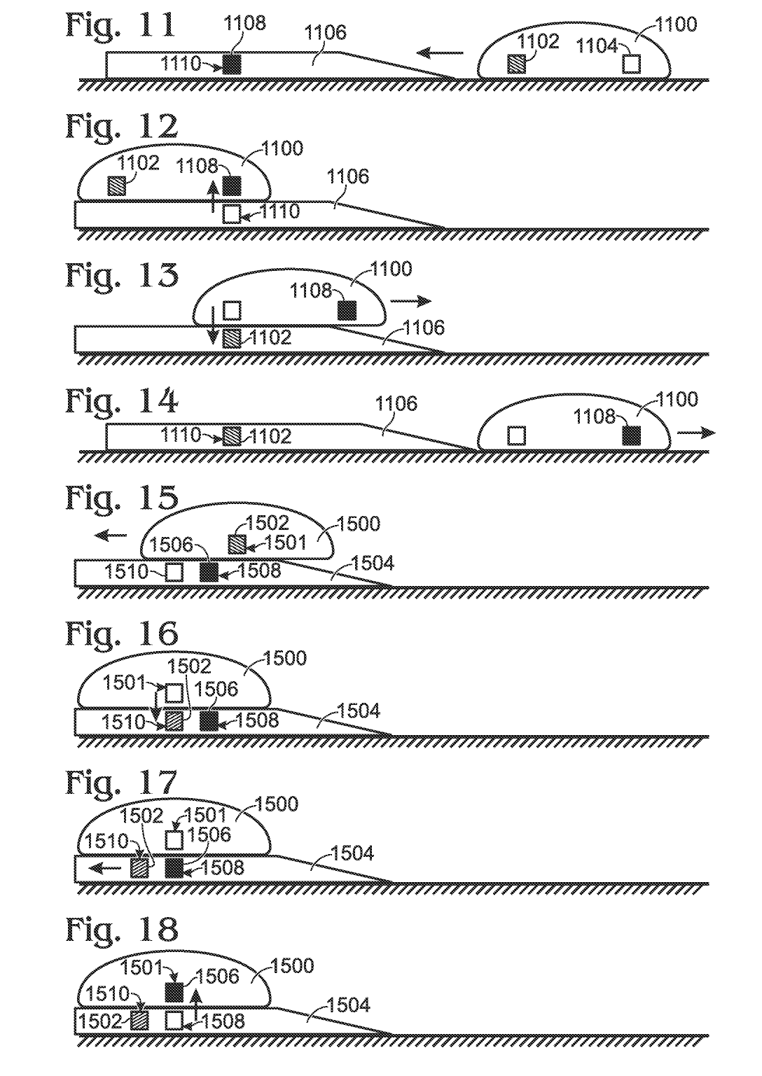

FIGS. 11-14 illustrate another embodiment of a method of exchanging a battery in an autonomous device. First referring to FIG. 11, an autonomous device 1100 comprises a discharged battery 1102, and an empty battery receptacle 1104. Likewise, a battery exchange dock 1106 comprises a freshly charged battery 1108 contained within a battery charger 1110. Next referring to FIG. 12, autonomous device 1100 moves onto battery exchange dock 1106 such that empty battery receptacle 1104 is positioned over freshly charged battery 1108. Battery exchange dock 1106 detects autonomous device 1100 engaging with battery exchange dock 1106, and in response, inserts freshly charged battery 1108 into empty battery receptacle 1104.

After receiving freshly charged battery 1108, autonomous device 1100 moves to locate discharged battery 1102 over battery charger 1110, as shown in FIG. 13. Such motion may be performed by autonomous device 1100 under battery power, and/or by a mechanism on battery exchange dock 1106. The discharged battery is moved out of autonomous device 1100, and autonomous device 1100 disengages from battery exchange dock 1106, as indicated in FIG. 14. Thus, in the embodiment of FIGS. 11-14, discharged battery 1102 is charged in a same battery charger receptacle as freshly charged battery 1108.

It will be understood that any suitable mechanism may be used to move charged and discharged batteries respectively into and out of the autonomous device, and that such mechanism may reside fully on either of the autonomous device or battery exchange dock, or be distributed between the two devices.

FIGS. 15-19 show another embodiment of a method of exchanging batteries in an autonomous device, wherein the battery charger of the battery exchange dock has a plurality of battery charging receptacles that may be moved into or out of alignment with a battery receptacle of an autonomous device engaged with the battery exchange dock. First referring to FIG. 15, an autonomous device 1500 comprises a battery receptacle 1501 holding a discharged battery 1502. Likewise, a battery exchange dock 1504 comprises a freshly charged battery 1506 in a first battery receptacle 1508 of a battery charger. Battery exchange dock 1504 further comprises an empty battery receptacle 1510 of the battery charger. Next referring to FIG. 16, autonomous device 1500 moves onto battery exchange dock 1504 such that discharged battery 1502 is positioned over empty battery receptacle 1510. Discharged battery 1502 is then moved into empty battery receptacle 1510 for charging.

Next referring to FIG. 17, freshly charged battery 1506 is shifted to a location beneath battery receptacle 1501 of autonomous device 1500, for example, via a moving belt mechanism or other suitable movement mechanism, and then moved vertically into battery receptacle 1501, as shown in FIG. 18. Thus, discharged battery 1502 is charged in a different battery charger receptacle than freshly charged battery 1506. It will be understood that the battery exchange dock may comprise a single battery charger and a mechanism configured to move different battery receptacles into engagement with the battery charger, or may include battery charging circuitry for each battery receptacle. As mentioned above, in some embodiments, autonomous device 1500 may include a secondary power supply, such as a secondary battery or capacitive charge storage device, configured to supply power to the autonomous device during battery exchange. In other embodiments, autonomous device 1500 may be configured to receive power from the battery exchange dock during a battery exchange process, or to power down during a battery exchange process.

While the batteries are depicted as being inserted into and removed from the autonomous device via vertical motion in the embodiments of FIGS. 11-14 and 15-18, it will be understood that a similar mechanism also may be used to insert and remove a battery via horizontal motion. For example, a battery exchange dock may include a side or end wall positioned next to an autonomous device during docking, wherein the battery exchange mechanism is contained in the wall and moves a battery from the wall into a battery receptacle on a side of the autonomous device.

In yet other embodiments, more than two batteries may be exchanged between autonomous device 1500 and battery exchange dock 1504 in such a manner that only a subset of batteries currently being used to power autonomous device 1500 are exchanged during each battery exchange process. As a more specific example of such an embodiment, three batteries may be exchanged between an autonomous device and battery exchange dock, such that two batteries are contained on the autonomous device during operation while a third battery is being charged. Then, during an exchange process, the freshly charged battery may be exchanged for a most-discharged battery on the autonomous device without powering down the autonomous device. Thus, in such embodiments, the battery exchange dock may be configured to charge multiple batteries and the autonomous device could be capable of holding multiple batteries. In this configuration, the autonomous device and battery exchange dock may negotiate a wide range of charging time, power storage, and power consumption scenarios for different situations. For example, if continuous availability with short breaks was desired, then the device and dock may exchange fewer batteries frequently. Likewise, if a long burst of uninterrupted activity was desired, then the device and dock may exchange and use a larger supply of batteries.

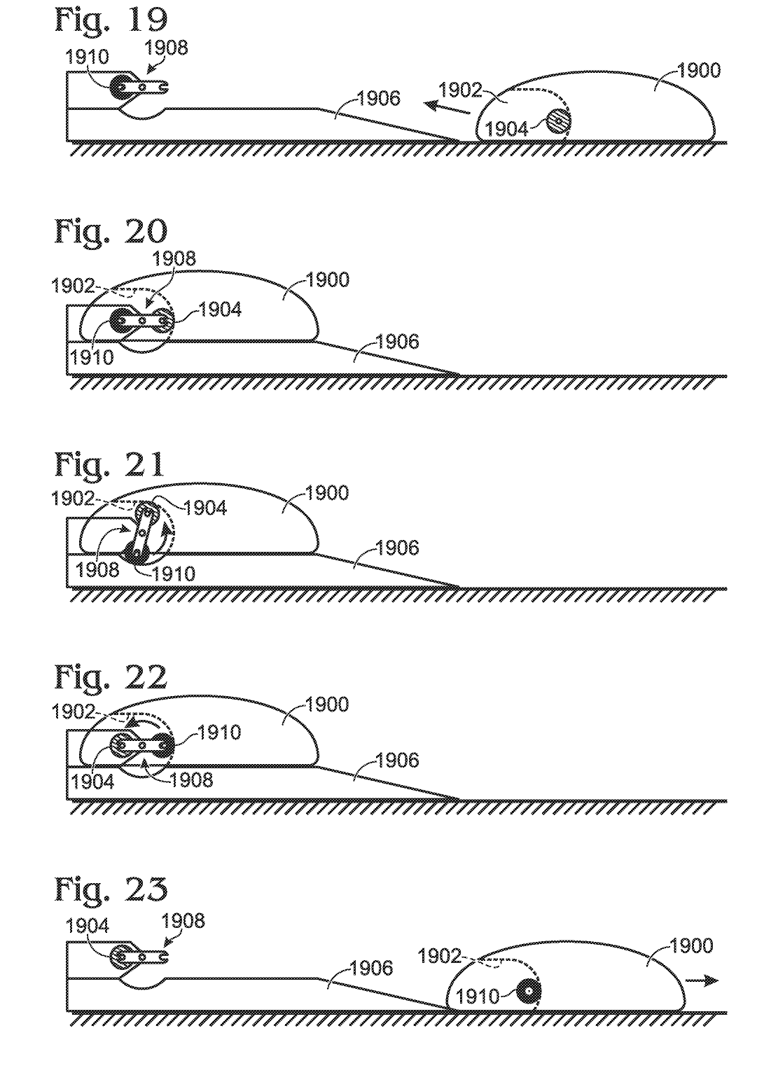

FIGS. 19-23 show yet another embodiment of a method of exchanging a battery in an autonomous device. Whereas the embodiments of 11-14 and 15-18 utilize vertical translational motion to move a battery into and out of an autonomous device combined with horizontal translation of the autonomous device or batteries within the dock, the embodiment of FIGS. 19-23 utilizes a rotational mechanism that rotates the discharged battery out of the autonomous device and rotates the charged battery into the autonomous device in a single motion. Yet other embodiments may utilize a curved path battery exchange mechanism, or any other suitable motion mechanism.

First referring to FIG. 19, an autonomous device 1900 comprises an opening 1902, such as a slot, that contains a battery receptacle holding a discharged battery 1904. Next referring to FIG. 20, autonomous device 1900 moves onto a battery exchange dock 1906 that comprises a rotational battery exchange mechanism 1908, and a battery charger that is currently holding a charged battery 1910.

Autonomous device 1900 moves onto battery exchange dock 1906 until discharged battery 1904 is engaged with rotational battery exchange mechanism 1908. Then, referring to FIGS. 21 and 22, rotational battery exchange mechanism 1908 rotates discharged battery from autonomous device 1900 into the battery charger, and in the same motion, rotates charged battery 1910 from the battery charger into autonomous device 1900. Then, referring to FIG. 23, autonomous device 1900 disengages from battery exchange dock 1906 while discharged battery 1904 charges. The rotation of rotational battery exchange mechanism may be power assisted, or may be mechanically driven by the movement of the autonomous device into engagement with the dock. While FIGS. 19-23 depict rotation of the battery exchange mechanism as occurring in a vertical plane, it will be understood that rotation may occur along any other suitable plane.

The rotational battery exchange mechanism may hold the batteries during exchange in any suitable manner. For example, as described above, the batteries may include interface features configured to couple with complementary interface features on the battery exchange mechanism. Likewise, in other embodiments, the batteries may be contained within holders, wherein the holders include interface features complementary to interface features on the battery exchange mechanism.

In this manner, an autonomous device may obtain a freshly-charged battery without having to wait for an on-board battery to charge at a battery charging station. While the embodiments herein are each shown as exchanging two batteries between a battery exchange dock and an autonomous device, it will be understood that any suitable number of batteries may be utilized.

As mentioned above, an autonomous device and battery exchange dock each may comprise a controller having a logic subsystem configured to execute instructions, and a data-holding subsystem configured to hold instructions executable by such logic subsystem to perform tasks related to exchanging batteries, charging batteries, etc. It is to be understood that such controllers may have any computer architecture without departing from the scope of this disclosure.

The above-described logic subsystems may include one or more physical devices configured to execute one or more instructions. For example, a logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

A logic subsystem may include one or more processors that are configured to execute software instructions. Additionally or alternatively, a logic subsystem may include one or more hardware or firmware logic machines configured to execute hardware or firmware instructions. Processors of a logic subsystem may be single core or multicore, and the programs executed thereon may be configured for parallel or distributed processing. A logic subsystem may optionally include individual components that are distributed throughout two or more devices, which may be remotely located and/or configured for coordinated processing. One or more aspects of a logic subsystem may be virtualized and executed by remotely accessible networked computing devices configured in a cloud computing configuration.

A data-holding subsystem may include one or more physical, non-transitory, devices configured to hold data and/or instructions executable by the logic subsystem to implement the herein described methods and processes. When such methods and processes are implemented, the state of a data-holding subsystem may be transformed (e.g., to hold different data).

In some embodiments, a data-holding subsystem may include removable computer-readable storage media and/or built-in devices. Such a data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. A data-holding subsystem further may include devices with one or more of the following characteristics: volatile, nonvolatile, dynamic, static, read/write, read-only, random access, sequential access, location addressable, file addressable, and content addressable. In some embodiments, a logic subsystem and data-holding subsystem may be integrated into one or more common devices, such as an application specific integrated circuit or a system on a chip.

Removable computer-readable storage media may be used to store and/or transfer data and/or instructions executable to implement the herein described methods and processes. Removable computer-readable storage media may take the form of CDs, DVDs, HD-DVDs, Blu-Ray Discs, EEPROMs, magnetic, and/or floppy disks, among others.

It is to be appreciated that a data-holding subsystem may include one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of operating an autonomous device, the method comprising:
autonomously moving to and operatively engaging with a battery exchange dock such that a discharged battery in the autonomous device is automatically removed from the autonomous device and placed into a charging receptacle on the battery exchange dock, and a charged battery is automatically received from the battery exchange dock by the autonomous device; and
autonomously disengaging from the battery exchange dock after receiving the charged battery.

2. The method of claim 1, wherein the charged battery is received into a first battery receptacle on the autonomous device before the discharged battery is removed from a second battery receptacle on the autonomous device.

3. The method of claim 2, further comprising moving the autonomous device relative to the battery exchange dock after receiving the charged battery and before removal of the discharged battery.

4. The method of claim 1, wherein the charged battery is inserted into a same battery receptacle from which the discharged battery was removed.

5. The method of claim 4, further comprising powering the autonomous device down after engaging with the battery exchange dock and before removal of the discharged battery.

6. The method of claim 4, further comprising receiving power from a secondary power supply on the autonomous device after the discharged battery is removed and before the charged battery is received.

7. The method of claim 4, further comprising receiving power from the battery exchange dock during battery exchange.

8. The method of claim 1, further comprising receiving the charged battery from the battery exchange dock via one or more arms movably coupled to the battery exchange dock.

9. The method of claim 1, further comprising wherein the discharged battery and the charged battery are exchanged via a mechanism on the battery exchange dock that comprises one or more of a rotational, translational, and curved path exchange mechanism.

10. An autonomous device, comprising:
a body;
a first battery receptacle and a second battery receptacle each configured to accommodate a battery to independently supply power to the autonomous device;
an electrically powered mobility subsystem;
a logic subsystem; and
a data-holding subsystem comprising instructions stored thereon that are executable by the logic subsystem to engage with a battery exchange dock to perform a battery exchange process in which a charged battery is received in one of the first battery receptacle and the second battery receptacle and a discharged battery is removed from another of the first battery receptacle and the second battery receptacle.

11. The autonomous device of claim 10, wherein the first battery receptacle and the second battery receptacle are located on different locations on the body of the autonomous device.

12. The autonomous device of claim 10, further comprising a first battery receptacle door for the first battery receptacle and a recess located between the first battery receptacle door and a body of the autonomous device, the recess being configured to accept insertion of a battery exchange arm of the battery exchange dock.

13. The autonomous device of claim 10, further comprising battery contacts disposed in the first battery receptacle and the second battery receptacle, the battery contacts comprising a feature configured to fit into a complementary recess on the battery.

14. The autonomous device of claim 13, further comprising a battery disposed in one of the first battery receptacle and the second battery receptacle, the battery comprising a complementary recess into which the feature extends.

15. The autonomous device of claim 10, further comprising a battery disposed in the first battery receptacle, the battery comprising an elongate body and an extension extending from each end of the elongate body, the extensions being configured to engage battery exchange arms on the battery exchange dock.

16. An autonomous device battery exchange dock, comprising:
a battery charger configured to charge a battery held in the battery exchange dock;
a battery exchange mechanism configured to exchange a first battery being charged on the battery exchange dock for a second battery in an autonomous device engaged with the battery exchange dock;
a data holding subsystem; and
a logic subsystem comprising instructions stored thereon that are executable by the data-holding subsystem to
charge the first battery via the battery charger,
detect the autonomous device engaging with the battery exchange dock,
upon detecting the autonomous device engaging with the battery exchange dock, move the second battery from the autonomous device into the battery charger of the battery exchange dock and move the first battery from the battery charger of the battery exchange dock into the autonomous device, and
charge the second battery in the battery charger.

17. The battery exchange dock of claim 16, wherein the battery charger comprises a plurality of battery charging receptacles, and wherein the instructions are executable to charge the first battery in a different battery charging receptacle than the second battery.

18. The battery exchange dock of claim 17, wherein the instructions are executable to remove the second battery from the autonomous device before placing the first battery in the autonomous device.

19. The battery exchange dock of claim 16, wherein the battery exchange dock is configured to charge the first battery in a same battery charging receptacle as the second battery.

20. The battery exchange dock of claim 19, wherein the instructions are executable to place the first battery in the autonomous device before removing the second battery from the autonomous device.
